(19) United States
(12) Patent Application Publication
(10) Pub. No.: US 2026/0095254 A1
(43) Pub. Date: Apr. 2, 2026

(54) INTEGRATED MODULATOR WITH AMPLIFIED OPTICAL EQUALIZER CIRCUIT

(71) Applicant: OpenLight Photonics, Inc., Goleta, CA (US)

(72) Inventors: John Sonkoly, Laguna Niguel, CA (US); Erik Johan Norberg, Santa Barbara, CA (US); Krzysztof Szczerba, Sunnyvale, CA (US); Beichen Wang, Sunnyvale, CA (US)

(21) Appl. No.: 18/904,526

(22) Filed: Oct. 2, 2024

(51) Int. Cl. H04B 10/516

(52) U.S. Cl. CPC H04B 10/516

(57) ABSTRACT

A device includes an optical modulator to modulate light to generate a modulated signal. An optical equalizer (OEQ) circuit includes a power splitter to receive the modulated signal, couple a first portion of the modulated signal onto a direct path, and couple a second portion of the modulated signal onto a delay path. A delay line introduces a delay into the second portion of the modulated signal traversing the delay path, and a phase shifter shifts a phase of the delayed modulated signal. The OEQ circuit includes a direct path amplifier to amplify the first portion of the modulated signal traversing the direct path and/or a delay path amplifier to amplify the second portion of the modulated signal traversing the delay path. A combiner combines the modulated signals received from the direct path and the delay path to generate a combined modulated signal.

### TECHNICAL FIELD

The present disclosure relates to optical communication systems and, in some examples, to methods and systems to enhance bandwidth and performance of integrated optical modulators using amplified optical equalizers.

### BACKGROUND

Optical communication systems are under growing pressure to meet the increasing demands for higher data transmission rates and bandwidth. As data traffic increases, there is a constant push to develop more advanced optical components and subsystems capable of handling higher speeds and greater volumes of information.

### BRIEF DESCRIPTION OF THE SEVERAL VIEWS OF THE DRAWINGS

The following description includes discussion of figures having illustrations given by way of example of implementations of embodiments of the disclosure. The drawings should be understood by way of example, and not by way of limitation. To easily identify the discussion of any particular element or act, the most significant digit or digits in a reference number may refer to the figure (“FIG.”) number in which that element or act is first introduced.

FIG. 1A (prior art) is a schematic diagram illustrating a system having a conventional optical equalizer.

FIG. 1B (prior art) is a schematic diagram illustrating a system having another conventional optical equalizer with an amplifier.

FIG. 2A is a schematic diagram illustrating a device having an optical equalizer circuit with a direct path amplifier, according to some examples.

FIG. 2B is a schematic diagram illustrating a device having an optical equalizer circuit with a direct path amplifier, and an output amplifier, according to some examples.

FIG. 2C is a schematic diagram illustrating a device having an optical equalizer circuit with a delay path amplifier, according to some examples.

FIG. 2D is a schematic diagram illustrating a device having an optical equalizer circuit with a delay path amplifier and an output amplifier, according to some examples.

FIG. 2E is a schematic diagram illustrating a device having an optical equalizer circuit with a direct path amplifier and a delay path amplifier, according to some examples.

FIG. 2F is a schematic diagram illustrating a device having an optical equalizer circuit with a direct path amplifier, a delay path amplifier, and an output amplifier, according to some examples.

FIG. 3A (prior art) is a schematic diagram illustrating a system with multiple cascaded delays.

FIG. 3B (prior art) is a schematic diagram illustrating a system with multiple cascaded delays and an amplifier.

FIG. 3C (prior art) is a schematic diagram illustrating a system with multiple cascaded delays and two amplifiers.

FIG. 3D (prior art) is a schematic diagram illustrating a system with multiple cascaded delays and three amplifiers.

FIG. 4A is a schematic diagram illustrating a device with multiple cascaded optical equalizer circuits as shown in FIG. 2A, according to some examples.

FIG. 4B is a schematic diagram illustrating a device with multiple cascaded optical equalizer circuits as shown in FIG. 2B, according to some examples.

FIG. 4C is a schematic diagram illustrating a device with multiple cascaded optical equalizer circuits as shown in FIG. 2F, according to some examples.

FIG. 5 is a flowchart illustrating an example method for optical signal processing, according to some examples.

FIG. 6 is a flowchart illustrating an example method for controlling and calibrating an integrated optical modulator and optical equalizer circuit, according to some examples.

Descriptions of certain details and implementations follow, including a description of the figures, which may depict some or all of the embodiments described below, as well as discussing other potential embodiments or implementations of the inventive concepts presented herein. An overview of example embodiments of the disclosure is provided below, followed by a more detailed description with reference to the drawings.

### DETAILED DESCRIPTION

One of the challenges in designing optical communication systems is achieving higher modulation rates while maintaining signal integrity. As data rates increase, traditional optical modulators face limitations in their ability to produce clean, high-quality signals at very high frequencies. This is due to various factors such as bandwidth constraints, signal distortion, and frequency-dependent losses.

Another challenge is managing the trade-offs among speed, power consumption, and signal quality. As modulation rates increase, it becomes increasingly difficult to maintain an acceptable balance between these parameters. Higher speeds often come at the cost of increased power consumption or degraded signal quality, which can lead to increased bit error rates and reduced transmission distances.

In addition to the technical problems of maintaining signal integrity at high modulation rates and managing the trade-offs among speed, power consumption, and signal quality as noted above, the field of optical communications also grapples with other technical problems. The complexities of integrating various optical and electronic components into compact, efficient systems present design challenges, which become more pronounced as systems are required to operate at higher speeds and with greater functionality. Furthermore, there is an ongoing effort to develop techniques that can extend the usable bandwidth of existing optical infrastructure. These techniques can include finding ways to compensate for signal degradation and distortion that occur at higher frequencies, without necessitating a complete overhaul of the existing optical network.

Examples described herein attempt to address these challenges in high-speed optical communication systems by integrating optical modulators with amplified optical equalizers (OEQs) to enhance bandwidth and performance. These examples aim to overcome one or more of the above-noted limitations of traditional optical modulators, particularly when operating at data rates of 400 Gigabits per second and beyond.

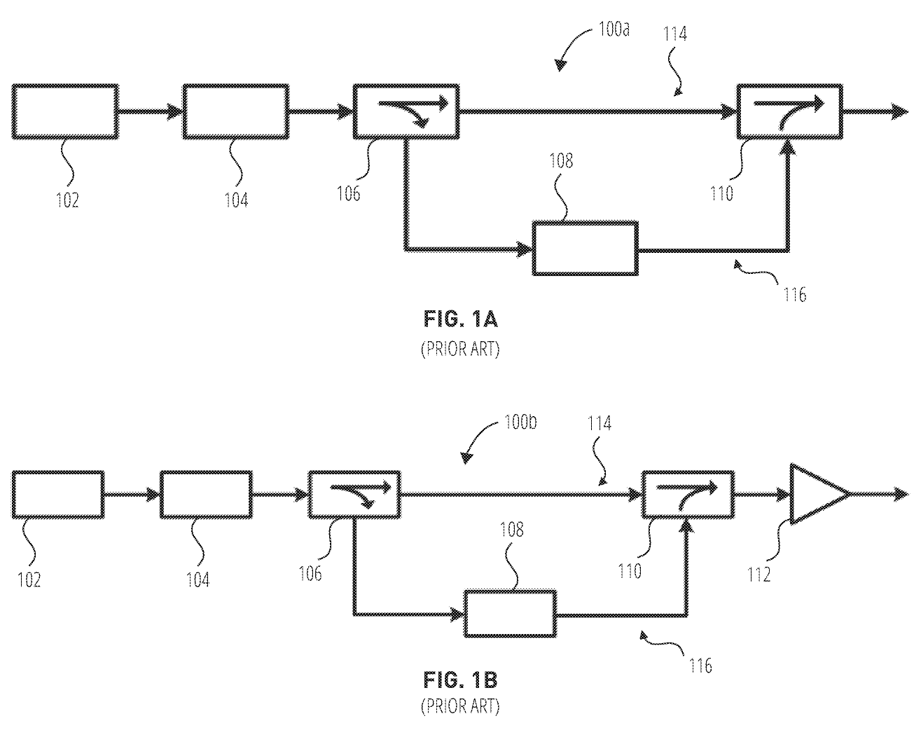

FIG. 1A is a schematic diagram illustrating a system having a conventional optical equalizer (OEQ) 100a. The system includes a laser 102, a modulator 104, and the conventional OEQ 100a; the conventional OEQ 100a includes a splitter 106, a direct path 114, a delay path 116, a delay 108, and a combiner 110.

The laser 102 generates an optical carrier signal. The modulator 104 receives the optical carrier signal from the laser 102 and modulates it with data to generate a modulated signal. The splitter 106 receives the modulated signal from the modulator 104 and splits it into two portions. One portion of the modulated signal is coupled onto the direct path 114, while the other portion is coupled onto the delay path 116.

The delay 108 is positioned in the delay path 116. It introduces a temporal offset to the portion of the modulated signal traversing the delay path 116. This temporal offset can create a delay between the modulated signals in the direct path 114 and the delay path 116. However, the delay is typically on the order of picoseconds, and is typically of a fixed duration, because the delay line cannot be adjusted.

The combiner 110 receives the modulated signals from both the direct path 114 and the delay path 116. It combines these signals to generate a combined modulated signal.

FIG. 1B is a schematic diagram illustrating another system having a conventional OEQ 100b with an amplifier 112. The conventional OEQ 100b comprises the same components as the conventional OEQ 100a in FIG. 1A, with the addition of an amplifier 112.

The amplifier 112 is positioned after the combiner 110. It amplifies the combined modulated signal output from the combiner 110. This amplification may compensate for insertion losses and improve the overall signal strength.

These conventional OEQ structures conventional OEQ 100a and conventional OEQ 100b may have limitations in terms of adjustability and performance optimization. Conventional optical modulators struggle to achieve high data rates, particularly at 400 Gigabits per second or higher, due to bandwidth limitations. In addition, as data rates increase, signal distortion and loss can become more pronounced, leading to degraded signal quality and reduced transmission distances. Furthermore, variations in the fabrication process can lead to inconsistent performance across devices, such as modulators implemented in a separate device from the conventional OEQ 100a or conventional OEQ 100b and/or the amplifier 112; this problem can be particularly acute in complex integrated photonic circuits.

Existing approaches to addressing these technical limitations introduce further problems or limitations. Improving modulator bandwidth often requires sacrificing other performance parameters, such as drive voltage efficiency. In addition, achieving high data rates often requires the use of complex and expensive electronic equalization techniques.

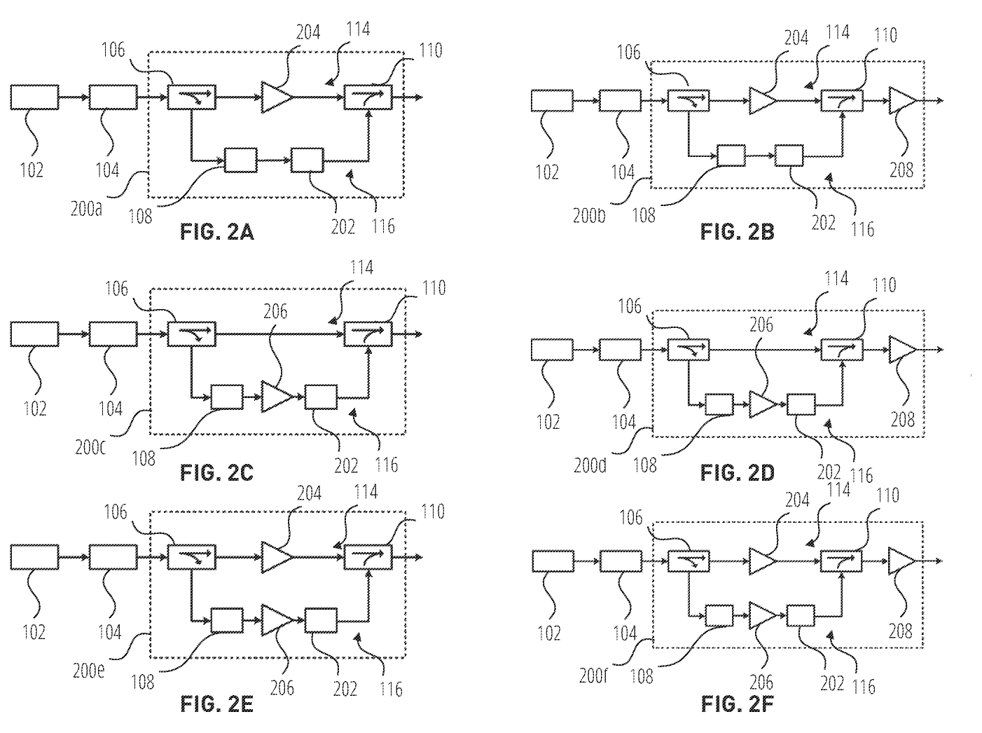

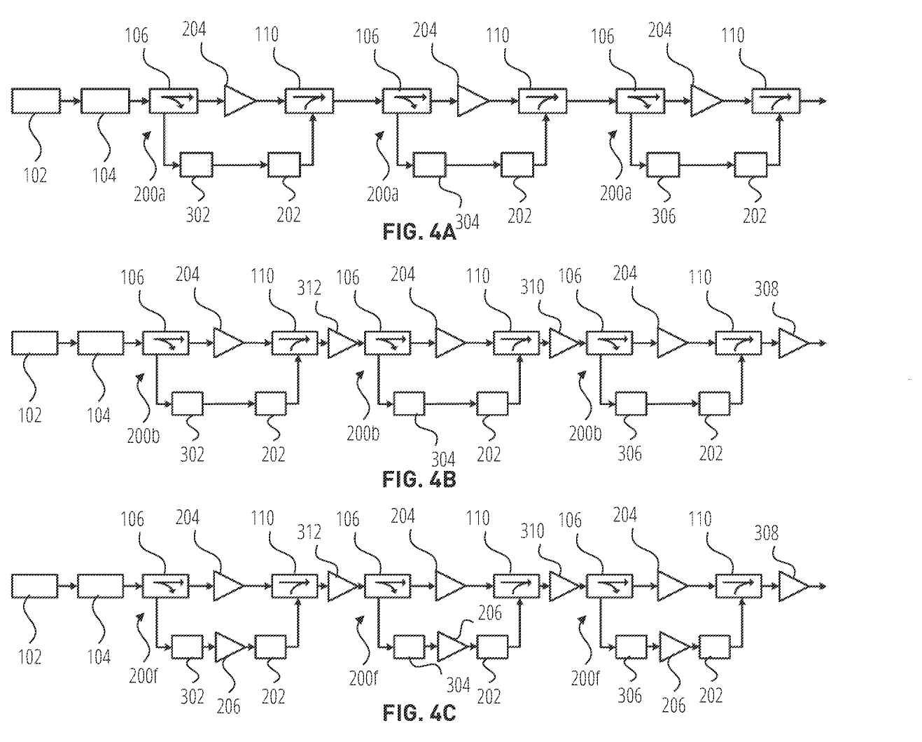

Examples are described herein that attempt to address one or more of these technical problems. FIG. 2A through FIG. 2F illustrate six different alternative structures for a single device having an optical modulator and optical equalizer circuit that may address one or more of the technical challenges of high-speed optical modulation described above. In some examples, the modulator and equalizer circuit can be integrated together onto a single device, such as a single PIC. FIG. 4A through FIG. 4C illustrate further examples of devices having multiple cascaded optical equalizer circuits according to one or more of the optical equalizer circuit configurations of FIG. 2A through FIG. 2F.

FIG. 2A is a schematic diagram illustrating a device having an optical equalizer (OEQ) circuit 200a with a direct path amplifier 204. The device includes a laser 102, a modulator 104, and the OEQ circuit 200a. The OEQ circuit 200a includes a splitter 106, a direct path 114, a delay path 116, a delay 108 and a phase shifter 202 on the delay path 116, a combiner 110, and a direct path amplifier 204.

The laser 102 generates light that is input to the modulator 104 as a carrier signal. The modulator 104 modulates the light to generate a modulated signal. The modulated signal is then input to the splitter 106, which is a power splitter in some examples.

The splitter 106 divides the modulated light to couple a first portion of the modulated signal onto the direct path 114 and couple a second portion of the modulated signal onto the delay path 116.

The delay 108 is positioned in the delay path 116. The delay 108 introduces a delay into the second portion of the modulated signal traversing the delay path 116, thereby generating a delayed modulated signal. In some examples, the delay 108 may introduce a delay of between 0.5 picoseconds and 10 picoseconds, such as 1 picosecond or 5 picoseconds.

The phase shifter 202 is positioned in the delay path 116 after the delay 108. The phase shifter 202 shifts a phase of the delayed modulated signal, thereby generating a phase-shifted modulated signal. In some examples, the phase shifter 202 is or includes a thermal tuner.

The direct path amplifier 204 is positioned in the direct path 114. The direct path amplifier 204 amplifies the first portion of the modulated signal traversing the direct path 114. In some examples, the direct path amplifier 204 is a semiconductor optical amplifier (SOA).

The combiner 110 receives the amplified first portion of the modulated signal from the direct path 114 and the phase-shifted modulated signal from the delay path 116. The combiner 110 combines these signals to generate a combined modulated signal.

In some examples, the optical equalizer circuit 200a can be used to compensate for frequency-dependent attenuation of the modulated signal caused by the modulator 104.

In some examples, the optical equalizer circuit 200a has a Mach-Zehnder interferometer (MZI) structure, with the direct path 114 forming a first arm and the delay path 116 forming a second arm.

FIG. 2B is a schematic diagram illustrating a device having an OEQ circuit 200b with a direct path amplifier 204 and an output amplifier 208. The OEQ circuit 200b comprises the same components as the OEQ circuit 200a, with the addition of an output amplifier 208.

The output amplifier 208 is positioned after the combiner 110. The output amplifier 208 amplifies the combined modulated signal generated by the combiner 110. This additional amplification stage may provide further signal enhancement or compensation.

FIG. 2C is a schematic diagram illustrating a device having an OEQ circuit 200c with a delay path amplifier 206. The OEQ circuit 200c comprises the same components as the OEQ circuit 200a, except that the direct path amplifier 204 is replaced with a delay path amplifier 206.

The delay path amplifier 206 is positioned in the delay path 116. The delay path amplifier 206 amplifies the second portion of the modulated signal traversing the delay path 116. In some examples, the delay path amplifier 206 may amplify the delayed modulated signal before the delayed modulated signal is received by the phase shifter 202.

FIG. 2D is a schematic diagram illustrating a device having an OEQ circuit 200d with a delay path amplifier 206 and an output amplifier 208. The OEQ circuit 200d combines the configurations of the OEQ circuits 200b and 200c, featuring both the delay path amplifier 206 and the output amplifier 208.

FIG. 2E is a schematic diagram illustrating a device having an OEQ circuit 200e with a direct path amplifier 204 and a delay path amplifier 206. The OEQ circuit 200e combines the amplification schemes of the OEQ circuits 200a and 200c, featuring both the direct path amplifier 204 and the delay path amplifier 206. This configuration allows for independent amplification of both the first and second portions of the modulated signal.

FIG. 2F is a schematic diagram illustrating a device having an OEQ circuit 200f with a direct path amplifier 204, a delay path amplifier 206, and an output amplifier 208. The OEQ circuit 200f represents the most comprehensive configuration, combining all the amplification stages from the previous circuits OEQ circuit 200a through OEQ circuit 200e. This configuration may provide the greatest flexibility in signal manipulation and compensation.

In some examples, as noted above, the optical modulator 104 and the optical equalizer circuit (200a-200f) can be integrated on a single photonic integrated circuit (PIC). The PIC can be a hybrid silicon-indium phosphide (Si-InP) PIC with one or more silicon layers and one or more indium phosphide layers. This integration may allow for compact and efficient implementation of the optical equalizer functionality.

In some examples, the optical modulator 104 can be implemented as an electro-absorption modulator (EAM) or a Mach-Zehnder modulator (MZM). The choice of modulator type may depend on specific application requirements and/or performance considerations.

In some examples, the device comprising the optical modulator 104 and the optical equalizer circuit (200a-200f) may be configured to operate at data rates of 400 Gigabits per second or higher. This high-speed operation capability may be achieved through the combined effects of the modulator and the equalizer circuit.

Thus, some examples of the devices of FIG. 2A through FIG. 2F can be used to address the technical challenges presented by the conventional devices of FIG. 1A and FIG. 1B.

In some examples, the bandwidth limitations of optical modulators can be addressed by integrating an optical modulator with an amplified optical equalizer circuit in a single integrated circuit, such as a PIC. The optical equalizer circuit compensates for the frequency-dependent attenuation caused by the modulator, and can be calibrated jointly with the modulator. The equalizer circuit employs a power splitter to divide the modulated signal into two paths: a direct path and a delay path. The delay path introduces a controlled delay and phase shift to the signal, while one or both paths may include optical amplifiers. By combining these modified signals, the equalizer can selectively amplify higher frequency components of the signal, effectively extending the overall bandwidth of the system. This allows the integrated device to operate at data rates of 400 Gigabits per second or higher.

In some examples, the signal distortion and loss in high-speed optical systems can be addressed by incorporating multiple amplification stages within the optical equalizer circuit to address signal distortion and loss. The direct path amplifier 204, delay path amplifier 206, and output amplifier 208 can be used in various combinations to optimize signal quality. For example, the direct path amplifier 204 can boost the signal before it undergoes equalization, while the delay path amplifier 206 can compensate for losses in the delay line. The output amplifier 208 provides a final boost to the equalized signal. By strategically placing these amplifiers and independently controlling the gain of the different amplifiers, the system can maintain higher modulated signal-to-noise ratio (OSNR) throughout the signal path, reducing the impact of noise and distortion.

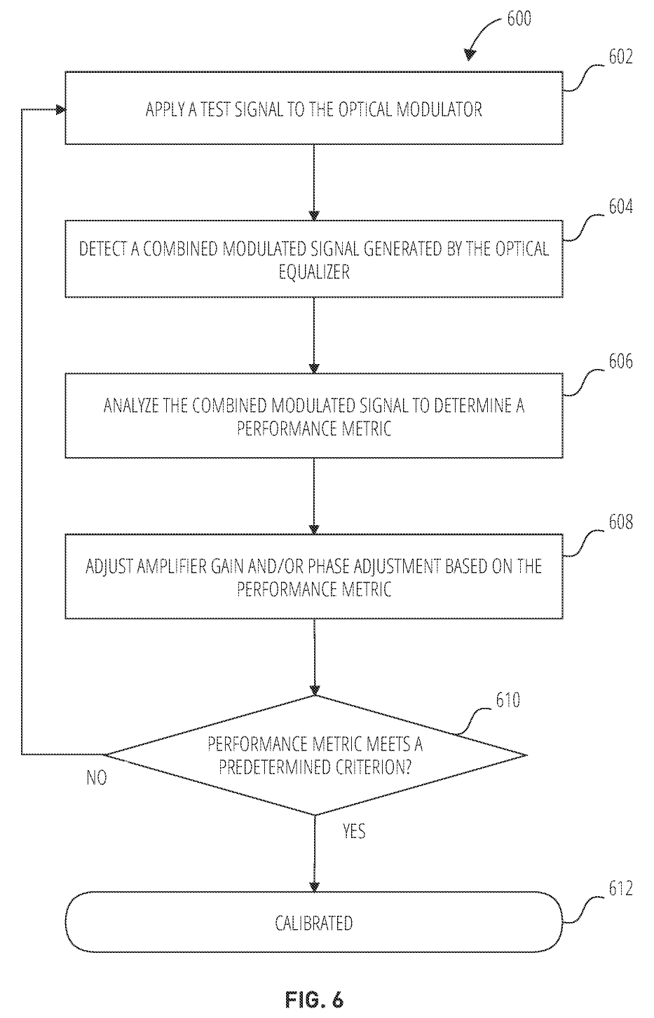

In some examples, the fabrication variability in integrated photonic circuits can be addressed by providing a highly adjustable architecture to compensate for fabrication variability. The phase shifter 202 allows for fine-tuning of the phase relationship between the direct and delay paths. The gain of the optical amplifiers (204, 206, and/or 208) can be dynamically adjusted to optimize the equalization response. This multi-dimensional adjustability can reduce or eliminate the need for additional components like an extra Mach-Zehnder Interferometer (MZI) for tuning, which is required in some existing conventional devices. The system can also include methods for calibrating and adjusting the optical equalizer circuit, as described in greater detail below with reference to FIG. 6. These methods can involve applying test signals, analyzing the output, and iteratively adjusting the phase and gain parameters until desired performance metrics are achieved.

In some examples, the trade-offs between modulator performance and drive voltage can be addressed by considering the modulator and equalizer as an integrated system. This co-design approach enables the modulator to be optimized for lower drive voltage rather than maximum bandwidth. The equalizer circuit can then compensate for the reduced bandwidth of the modulator. For example, an electro-absorption modulator (EAM) or Mach-Zehnder modulator (MZM) can be designed with a lower drive voltage, potentially improving power efficiency. The optical equalizer circuit then provides the necessary high-frequency boost to achieve the target overall system bandwidth. This approach can provide greater flexibility in balancing various performance parameters of the integrated device.

In some examples, the complexity and cost of high-speed optical transmitters can be addressed by shifting some of the equalization burden from the electrical to the optical domain, potentially reducing the complexity and cost of the overall system. By integrating the modulator and optical equalizer on a single photonic integrated circuit (PIC), such as a hybrid Si-InP platform, the system can achieve compact and cost-effective implementation. The optical equalization approach may be more effective at very high data rates compared to electrical equalization techniques. Furthermore, the adjustable nature of the optical equalizer circuit, with its various amplification stages and phase control, provides a wide optimization space that can be adapted for different situations and requirements without changing the hardware design.

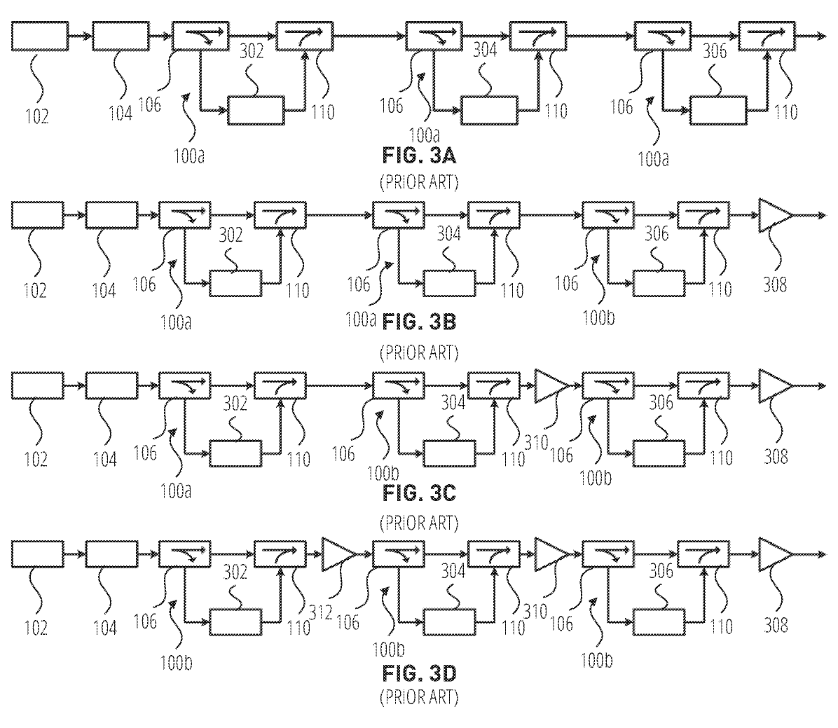

FIG. 3A is a schematic diagram illustrating a prior art system with multiple delays. The system includes a laser 102, a modulator 104, and multiple conventional OEQs 100a of the configuration shown in FIG. 1A. Each conventional OEQ 100a includes a splitter 106 and a combiner 110, and the delay line of each conventional equalizer has a delay line introducing a distinct respective delay: delay d1 302, delay d2 304, or delay d3 306.

The laser 102 generates an optical carrier signal, which is then modulated by the modulator 104 to impart data onto the optical carrier. The modulated signal is then input to the splitter 106, which divides the signal between the direct line and the delay line.

Each conventional OEQ 100a has a delay path implementing a respective delay line (d1302, d2 304, or d3 306) that each introduce a different respective temporal offset to the portion of the modulated signal traversing that path. These multiple delay paths create a more complex interference pattern when recombined, potentially allowing for more sophisticated equalization of the modulated signal.

Each combiner 110 receives and combines the signals from the direct path and the delay path of the respective conventional equalizer, producing a combined modulated signal. Thus, the first combiner 110 generates a first combined signal that includes a portion of the original modulated signal delayed by delay d1 302; the first combiner 110 generates a second combined signal that includes a portion of the first combined signal delayed by delay d2 304; and the third combiner 110 generates a third combined signal that includes a portion of the second combined signal delayed by delay d3 306. These multiple cascaded delay paths can be used to perform more complex equalization than a single conventional OEQ 100a or conventional OEQ 100b, but the system shown in FIG. 3A continues to exhibit many of the limitations of other conventional systems described above.

FIG. 3B is a schematic diagram illustrating a prior art system with multiple delays and an amplifier. This system includes all components from FIG. 3A, with the addition of an amplifier a3 308, such that the third conventional equalizer has the configuration of a conventional OEQ 100b of FIG. 1B.

The amplifier a3 308 is positioned after the third combiner 110. It amplifies the third combined modulated signal, potentially compensating for insertion losses and improving overall signal strength. The overall system configuration of FIG. 3B is therefore similar to the conventional OEQ 100b shown in FIG. 1B, but with multiple delay paths and multiple delays instead of a single delay path with a single delay.

FIG. 3C is a schematic diagram illustrating a prior art system with multiple delays and two amplifiers. This system builds upon the configuration in FIG. 3B by adding another amplifier a2 310, such that the second conventional equalizer and the third conventional equalizer both have the configuration of a conventional OEQ 100b of FIG. 1B.

The amplifier a2 310 is positioned after the second conventional OEQ, providing additional flexibility in adjusting the strengths of the signals.

FIG. 3D is a schematic diagram illustrating a prior art system with multiple delays and three amplifiers. This system further expands on the previous configurations by adding a third amplifier a1 312, such that all three of the conventional equalizers have the configuration of a conventional OEQ 100b of FIG. 1B.

The amplifier a1 312 is positioned after the first conventional OEQ 100b, allowing for further control over the strengths of the signals.

These prior art systems with multiple delays (FIG. 3A-3D) demonstrate an approach to optical equalization that relies on creating complex interference patterns through multiple delay paths. The progressive addition of amplifiers in each figure shows an evolution towards more sophisticated control over the equalization process. However, these systems still lack the integrated phase control and the strategic placement of amplifiers within the equalizer structure that are featured in the configurations shown in FIG. 2A-FIG. 2F.

In contrast to the systems shown in FIG. 2A-FIG. 2F, these prior art systems do not integrate the modulator and equalizer on a single platform, which may limit the potential for co-optimization of these components. Additionally, the lack of adjustable phase control in these prior art systems may restrict their ability to fine-tune the equalization response, particularly for high-speed optical communication systems operating at data rates of 400 Gigabits per second or higher. Finally, the prior art systems cannot adjust the relative amplification of the direct and delay paths of any of the individual OEQs, significantly limiting their ability to perform complex equalization.

Accordingly, instead of cascading multiple conventional optical equalizers of the types shown in FIG. 1A or FIG. 1B, examples are provided in FIG. 4A to FIG. 4C of various cascaded arrangements of one or more of the optical equalizer circuits of FIG. 2A-FIG. 2F.

FIG. 4A is a schematic diagram illustrating a device with multiple cascaded OEQ circuits 200a configured as shown in FIG. 2A. The device includes a laser 102, a modulator 104, and three OEQ circuits 200a. Each OEQ circuit 200a has a splitter 106 and a combiner 110, with a direct path including a direct path amplifier 204, and a delay path including a distinct respective delay line (shown as delay d1 302, delay d2 304, and delay d3 306) and a phase shifter 202.

The laser 102 generates light that is input to the modulator 104. The modulator 104 modulates the light to generate a modulated signal. This modulated signal is then processed by a cascade of optical equalizer circuits, each similar in structure to the OEQ circuit 200a described in FIG. 2A.

The device incorporates elements from both the advanced optical equalizer circuits shown in FIG. 2A-FIG. 2F and the multiple delay structures shown in FIG. 3A-FIG. 3D. A phase shifter 202 is positioned in each of the delay paths, allowing for adjustable phase control of the delayed modulated signal. This phase adjustment capability enables fine-tuning of the interference between the multiple delayed signals.

The cascade arrangement consists of multiple optical equalizer OEQ circuits 200a connected in series. The combined modulated signal generated by each prior optical equalizer OEQ circuit 200a in the cascade is received by a power splitter 106 of a subsequent optical equalizer OEQ circuit 200a in the cascade. This configuration allows for more complex equalization of the modulated signal.

Each optical equalizer OEQ circuit 200a in the cascade includes a splitter 106, which couples a portion of the incoming modulated signal onto a direct path and another portion onto a delay path. The delay paths contain delay lines, each introducing a respective delay: delay d1 302, delay d2 304, and delay d3 306, respectively. These delay lines introduce different delays into the modulated signal traversing their respective delay paths.

The phase shifter 202 in each OEQ circuit 200a shifts the phase of the delayed modulated signal. The direct path amplifier 204 amplifies the portion of the modulated signal traversing the direct path. The combiner 110 in each circuit combines the signals from the direct and delay paths to generate a combined modulated signal, which then serves as the input for the next equalizer circuit in the cascade (or the output of the device).

In some examples, the phase shifters 202 and/or the direct path amplifiers 204 can be independently controlled, thereby enabling highly controllable, frequency-dependent equalization.

FIG. 4B is a schematic diagram illustrating a device with multiple cascaded OEQ circuits 200b as shown in FIG. 2B. The system comprises the same components as in FIG. 4A, with the addition of an amplifier a3 308, an amplifier a2 310, and an amplifier a1 312.

This configuration incorporates an output amplifier (amplifier a1 312, amplifier a2 310, and amplifier a3 308) after each combiner 110 in the cascade. These amplifiers may provide additional signal boost and compensation at each stage of the equalization process. In some examples, each of the three amplifiers can be independently controlled to apply a distinct and adjustable amount of gain to its input signal.

FIG. 4C is a schematic diagram illustrating a device with multiple cascaded OEQ circuits 200f as shown in FIG. 2F. The device comprises the same components as in FIG. 4B, with the addition of a delay path amplifier 206 in each of the optical equalizer circuits.

In this configuration, each OEQ circuit 200f in the cascade includes both a direct path amplifier 204 and a delay path amplifier 206. The delay path amplifier 206 amplifies the portion of the modulated signal traversing the delay path (in this example, the delayed signal prior to phase-shifting), providing additional flexibility in signal manipulation and equalization. It will be appreciated that, in some examples, the order of the delay line, the delay path amplifier 206, and the phase shifter 202 can be rearranged in one or more of the optical equalizer circuits described herein.

The cascaded arrangement of optical equalizer circuits in the devices of FIG. 4A to FIG. 4C may allow for more sophisticated equalization of the modulated signal. Each stage in the cascade may be optimized to address different aspects of signal distortion or attenuation, potentially enabling more effective compensation for complex frequency-dependent effects introduced by the modulator or transmission medium.

In some examples, each optical equalizer circuit of the cascade has a delay line in its delay path introducing a delay (e.g., delay d1 302) that is different from the delay introduced by the delay line of each other optical equalizer circuit of the cascade (e.g., delay d2 304 and delay d3 306). Thus, delay d1 302 may be different in duration from delay d2 304, which may also be different in duration from delay d3 306. This variation in delay times across the cascade may enable the overall system to address a wider range of frequency-dependent effects, potentially improving the overall bandwidth and signal quality of the integrated modulator and equalizer system.

The cascaded configurations shown in FIG. 4A through FIG. 4C may provide enhanced flexibility in adapting to various signal distortions and may enable operation at higher data rates. In some examples, this cascaded arrangement may facilitate operation at data rates of 400 Gigabits per second or higher.

Whereas only three examples of devices having cascaded optical equalizer circuits are shown in FIG. 4A through FIG. 4C, it will be appreciated that some examples may cascade more or fewer than three optical equalizer circuits, and/or may cascade optical equalizer circuits of one or more types of any of the six different types of optical equalizer circuits shown in FIG. 2A through FIG. 2F. Thus, FIG. 4A, FIG. 4B, and FIG. 4C represent only three examples selected from a wide range of possible cascaded arrangements of the various optical equalizer circuit types from FIG. 2A through FIG. 2F.

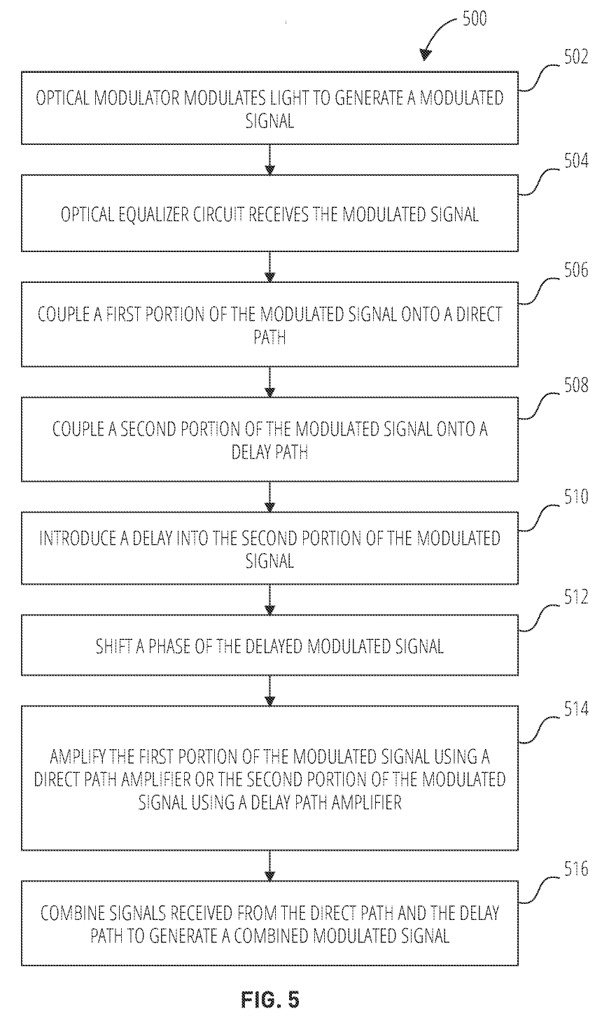

FIG. 5 is a flowchart illustrating an example method 500 for optical signal processing. The method 500 is described with reference to the optical equalizer circuits of FIG. 2A through FIG. 2F, and/or the devices of FIG. 4A through FIG. 4C. However, it will be appreciated that the method 500 can in some examples be performed by devices that differ from the example devices described herein.

Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method 500 includes using an optical modulator 104 to modulate light to generate a modulated signal at operation 502.

According to some examples, the method 500 includes using an optical equalizer circuit (such as any of OEQ circuit 200a through OEQ circuit 200f) to receive the modulated signal at operation 504. Subsequent operations 506 through 514 are performed to equalize the received modulated signal. In some examples, these equalization operations are performed to compensate for frequency-dependent attenuation of the modulated signal caused by the optical modulator 104.

According to some examples, the method 500 includes coupling a first portion of the modulated signal onto a direct path 114 at operation 506. According to some examples, the method 500 includes coupling a second portion of the modulated signal onto a delay path 116 at operation 508. A splitter 106, such as a power splitter, can be used to perform operations operation 506 and operation 508 in some examples.

According to some examples, the method 500 includes introducing a delay into the second portion of the modulated signal at operation 510. The delay can be introduced by a delay line, such as delay 108, in the delay path.

According to some examples, the method 500 includes shifting a phase of the delayed modulated signal at operation 512. The phase can be shifted by a phase shifter 202 in the delay path. Whereas the example devices illustrated herein use the phase shifter 202 to adjust the phase of the signal after it has been delayed by the delay 108, in some examples the order of these components (and so the order of operations operation 512 and 510) can be reversed or rearranged.

According to some examples, the method 500 includes amplifying the first portion of the modulated signal using a direct path amplifier 204, or amplifying the second portion of the modulated signal using a delay path amplifier 206, at operation 514. In OEQ circuit 200a or OEQ circuit 200b, a direct path amplifier 204 is used. In OEQ circuit 200c or OEQ circuit 200d, a delay path amplifier 206 is used. In OEQ circuit 200e or OEQ circuit 200f, both a direct path amplifier 204 and a delay path amplifier 206 are used.

According to some examples, the method 500 includes combining signals received from the direct path and the delay path to generate a combined modulated signal at operation 516. In some examples, a combiner 110 can be used to generate the combined modulated signal.

It will be appreciated that additional details and operations of the method 500 can conform to the various example devices described above with reference to FIG. 2A-FIG. 2F and/or FIG. 4A-FIG. 4C. For example, the combined modulated signal can be amplified by a further amplifier (e.g., an output amplifier 208 of OEQ circuit 200b, OEQ circuit 200d, or OEQ circuit 200f), and/or the amplified or unamplified combined modulated signal can then be further processed by one or more additional optical equalizer circuits cascaded with the first optical equalizer circuit.

FIG. 6 is a flowchart illustrating an example method 600 for controlling and calibrating an integrated optical modulator and optical equalizer circuit. The method 600 is described with reference to the optical equalizer circuits of FIG. 2A through FIG. 2F, and/or the devices of FIG. 4A through FIG. 4C. However, it will be appreciated that the method 600 can in some examples be performed by devices that differ from the example devices described herein.

Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

In some examples, the method 600 is performed in accordance with a first example control and calibration method for the integrated modulator and amplified optical equalizer circuit (such as one of the devices shown in any of FIG. 2A to FIG. 2F). The first example method involves a closed-loop control system based on an amplitude signal monitor. This monitor can be implemented as a detector connected to an output port of the combiner 110 at the output of the optical equalizer circuit.

The first example control and calibration method employs two primary control mechanisms: phase control and gain control.

Phase control aims to maintain the combined modulated signal from the output port at its maximum signal strength. This can be achieved by applying a low-frequency dither signal (e.g., 1 kHz) to the phase shifter 202. The monitor detector signal is then read and processed using a Fourier transform, which can be performed by a microcontroller. At the target phase operation point, the fundamental frequency component is at its weakest, while the second harmonic is at its strongest. The phase shifter bias is adjusted accordingly to maintain this optimal point.

Gain control in the first example control and calibration method operates by comparing a DC signal strength (e.g., a signal strength of a zero-frequency component of the Fourier transform) and a second harmonic amplitude of the monitor detector signal with pre-calibrated values. This comparison allows for precise adjustment of the amplifier gain within the optical equalizer circuit.

In some examples, the first example control and calibration method uses a dither signal at 1 kHz, modulating the phase within a range of [-20°, 20°]. The Fourier transform of the monitor detector signal is analyzed with respect to phase variation. This analysis enables the system to find the optimal phase point by identifying the weakest fundamental frequency and the strongest second harmonic. For gain control, the first example control and calibration method examines the power difference between the DC component and the second harmonic of the Fourier-transformed signal. This difference is compared to pre-calibrated values to determine the appropriate gain setting.

The first example control and calibration method can allow for dynamic adjustment of the optical equalizer circuit, compensating for variations in fabrication and operating conditions, and maintaining optimal performance of the integrated modulator and equalizer system.

In some examples, the method 600 is performed in accordance with a second example control and calibration method for the integrated modulator and amplified optical equalizer circuit. The second example control and calibration method also utilizes a closed-loop control system based on an amplitude signal monitor connected to an output port of the combiner 110 at the output of the optical equalizer circuit.

Phase control in the second example control and calibration method applies a low-frequency ramp signal (e.g., with a rise time of 1ms) to the phase shifter 202 instead of a dither signal. The monitor detector signal is read and processed by calculating its first and second derivatives with respect to time, which can be performed by a microcontroller. At the target phase operation point, the first derivative is zero. This approach allows for precise identification of the optimal phase adjustment to be applied to the phase shifter 202.

Gain control in the second example control and calibration method is achieved by comparing the second derivative of the monitor detector signal with pre-calibrated values. This comparison enables accurate adjustment of the amplifier gain within the optical equalizer circuit.

The second example control and calibration method can use a ramp signal with a rise time of 1ms, modulating the phase within a range of [-20°, 20°].

The first and second derivatives of the monitor detector signal are analyzed with respect to phase variation. This analysis enables the system to find the optimal phase point by identifying where the first derivative equals zero. For gain control, the second example control and calibration method examines the ratio between the second derivative and the zeroth derivative (original signal) of the monitor detector signal. This ratio is compared to pre-calibrated values to determine the appropriate gain setting.

The second example control and calibration method can provide potential advantages in terms of noise immunity and precision compared to the first example control and calibration method. By using derivatives rather than Fourier transforms, the second example control and calibration method may be less susceptible to certain types of noise and interference.

In some examples, an additional third example method for gain control can be used, which involves adding another monitor photodetector before the optical equalizer circuit. For example, an optical tap can be added between the modulator 104 and the splitter 106 to couple a small portion (e.g., 1%) of the modulated signal into a detector. This approach allows for a direct comparison of input and output power levels, potentially providing more accurate gain control. Like the first example control and calibration method, this third example control and calibration method can provide dynamic adjustment of the optical equalizer circuit, compensating for variations in fabrication and operating conditions, and maintaining optimal performance of the integrated modulator and equalizer system.

Method 600 can encompass one or more of the example control and calibration methods described above.

According to some examples, the method 600 includes applying a test signal to the optical modulator (such as a modulator 104 of any of the devices of FIG. 2A through FIG. 2F or FIG. 4A through FIG. 4C) at operation 602. For example, the test signal can be a high speed data signal suitable for forming an eye diagram or other test pattern for measuring the characteristics of an output signal of the device.

According to some examples, the method 600 includes detecting a combined modulated signal generated by the device (such as the combined modulated signal generated by an optical equalizer circuit or a series of cascaded optical equalizer circuits) at operation 604. The combined modulated signal can be measured at an output port of one of the optical equalizer circuits, as described above, or at the output of an output amplifier 208. In some examples, operation 604 also includes measuring the modulated signal at a tap prior to the combiner 110, in accordance with the third example control and calibration method described above.

According to some examples, the method 600 includes analyzing the combined modulated signal to determine at least one performance metric at operation 606. In some examples, in accordance with the first example control and calibration method described above, determining the performance metrics can include, first, performing a Fourier transform on the combined modulated signal, second, identifying a fundamental frequency component of the Fourier transform of the combined modulated signal, third, identifying a second harmonic component of the Fourier transform of the combined modulated signal, and fourth, identifying a zero-frequency component of the Fourier transform of the combined modulated signal.

In some examples, in accordance with the second example control and calibration method described above, determining the performance metrics can include determining a first derivative of the combined modulated signal and a second derivative of the combined modulated signal.

In some examples, in accordance with the third example method for gain control described above, determining the performance metrics can include comparing the input power level of the pre-splitter optical signal and the output power level of the post-combiner modulated signal.

According to some examples, the method includes adjusting the amplifier gain of one or more amplifiers (e.g., direct path amplifier 204, delay path amplifier 206, and/or output amplifier 208) and/or adjusting the phase adjustment of the phase shifter 202 based on the performance metric at operation 608.

In some examples, in accordance with the first example control and calibration method described above, operation 608 can include adjusting a bias of the phase shifter 202 to minimize the fundamental frequency component and maximize the second harmonic component measured at operation 606. The gain of an amplifier (e.g., direct path amplifier 204, delay path amplifier 206, or output amplifier 208) can be adjusted based on the comparison of the DC or zero-frequency signal strength of the Fourier transform and the second harmonic amplitude of the Fourier transform with pre-calibrated values.

In some examples, in accordance with the second example control and calibration method described above, operation 608 can include adjusting a bias of the phase shifter 202 to a phase adjustment value corresponding to the zero value of the first derivative of the monitor detector signal. The gain of an amplifier (e.g., direct path amplifier 204, delay path amplifier 206, or output amplifier 208) can be adjusted based on the comparison of the second derivative of the monitor detector signal with pre-calibrated values.

In some examples, in accordance with the third example control and calibration method described above, operation 608 can include adjusting the gain control of the amplifier based on the comparison of the input and output signal strength of the modulated signal pre-equalizer and post-equalizer.

According to some examples, the method 600 includes determining whether the at least one performance metric meets at least one respective predetermined criterion at operation 610. Examples of performance criteria used in calibrating or controlling the device at operation 610 can include maintaining a bandwidth greater than 100 GHz with a tolerance of ±0.5 dB (±10%) to the control signal, keeping the peaking of the frequency response below 2 dB, and/or achieving an insertion loss of less than 3 dB during calibration and control.

If the performance criteria are satisfied at operation 610, the method 600 proceeds to operation 612, at which point the device is deemed to be calibrated or is not subject to further corrective control during operation. If the performance criteria are not satisfied at operation 610, the method 600 returns to operation 602 to repeat operations 602 through 610 until the device is deemed to meet the performance criteria.

Simulations have been performed of the performance of various of the examples described herein, yielding results that suggest significant improvement over existing approaches in one or more respects. First, the simulations demonstrate the potential effectiveness of an integrated modulator-OEQ device in enhancing the bandwidth of the modulator output. For a conventional standalone electro-absorption modulator (EAM), the 3-dB bandwidth is simulated to be around 48.83 GHz, representing a typical baseline for existing approaches. However, when a modulator is combined with an OEQ circuit as described herein (e.g., as the device shown in FIG. 2A incorporating OEQ circuit 200a), the bandwidth can potentially be increased. For example, with a 1 picosecond (ps) delay in the OEQ (e.g., delay 108 of OEQ circuit 200a = 1 ps) and a gain of 3 dB applied by an amplifier (e.g., direct path amplifier 204 of OEQ circuit 200a), the simulated 3-dB bandwidth extends to 388.18 GHz, showing a substantial improvement in high-frequency performance.

The simulations also suggest a significant impact of varying the gain in the OEQ. With a 5 ps delay (e.g., delay 108 of OEQ circuit 200a = 5 ps) and amplifier gain values ranging from 7 dB to 13 dB, the simulated device exhibits different trade-offs between bandwidth, insertion loss (IL), and peaking. In one configuration, a bandwidth of 104.98 GHz can be achieved with a gain of 12 dB, meeting the performance criteria of bandwidth > 100 GHz, peaking < 2 dB, and IL < 3 dB.

Tolerance analysis shows that this simulated device can maintain performance within ±0.5 dB (±10%) of the target bandwidth for phase variations between -30° and 30°, and gain variations between 11 dB and 13 dB. This demonstrates the robustness of the simulated example to fabrication and operational variations.

Some simulations have been performed to compare different equalization approaches. These simulations suggest that some examples of optical equalization with gain compensation described herein can achieve both high optical modulation amplitude (OMA) and a high extinction ratio (ER), unlike electrical equalization (which reduces both) or optical equalization without gain (which only maintains ER).

In some examples, the different designs for the optical equalizer circuits described herein can be selected based on the intended effects on the modulated signal. Semiconductor optical amplifiers (SOAs) can cause various impairments to the modulated signal in the context of the integrated modulator and optical equalizer systems, and the placement of the SOAs (e.g., whether to use a direct path amplifier 204, a delay path amplifier 206, or both, and whether to use an output amplifier 208) can affect signal quality differently under different input power conditions. For low optical input power, having the SOA inside the loop (e.g., not as an output amplifier 208) can lead to better optical signal-to-Noise Ratio (OSNR). This is because low input power to an SOA results in increased noise, therefore the SOA is placed earlier in the link where the power is higher. However, for high optical input power, placing the SOA after the loop (as an output amplifier 208) may be preferable. This is because high optical input powers can distort the signal in the SOA. In some cases, excessive SOA gain can distort the signal due to a data pattern effect. This occurs when there is incomplete recovery of the SOA gain between excitation pulses. To address these issues, it may be preferable in some cases to use a low-gain SOA inside the loop (e.g., a direct path amplifier 204 and/or delay path amplifier 206) and another low-gain SOA outside the loop (e.g., an output amplifier 208). This flexibility in design can be regarded as a further potential advantage of the integrated modulator and amplified OEQ approaches examples described herein.

In the foregoing description, for the purposes of explanation, numerous specific details have been set forth in order to provide an understanding of various example embodiments of the inventive subject matter. It will be evident, however, to those skilled in the art, that example embodiments of the inventive subject matter may be practiced without these specific details. In general, well-known instruction instances, structures, and techniques are not necessarily shown in detail.

As used herein, references to one or more “examples” or "embodiments" are to be understood as describing a particular feature, structure, or characteristic included in at least one implementation of the inventive subject matter, in at least some circumstances. Thus, phrases such as “in one example”, “in some examples”, “in some embodiments”, "in one embodiment" or "in an alternate embodiment" appearing herein describe various embodiments and implementations of the inventive subject matter, and do not necessarily all refer to the same embodiment. However, they are also not necessarily mutually exclusive.

Other examples of optical devices, systems, and methods may include features, and combinations or subcombinations of features, of the various examples described herein. In view of the disclosure above, various examples are set forth below. It should be noted that one or more features of an example, taken in isolation or combination, should be considered within the disclosure of this application.

Example 1 is a device comprising: an optical modulator to modulate light to generate a modulated signal; and an optical equalizer (OEQ) circuit comprising: a power splitter to receive the modulated signal, couple a first portion of the modulated signal onto a direct path, and couple a second portion of the modulated signal onto a delay path; a delay line to introduce a delay into the second portion of the modulated signal traversing the delay path, thereby generating a delayed modulated signal; a phase shifter to shift a phase of the delayed modulated signal, thereby generating a phase-shifted modulated signal; an optical amplifier comprising one of: a direct path amplifier to amplify the first portion of the modulated signal traversing the direct path; or a delay path amplifier to amplify the second portion of the modulated signal traversing the delay path; and a combiner to combine the first portion of the modulated signal received from the direct path and the phase-shifted modulated signal received from the delay path to generate a combined modulated signal.

In Example 2, the subject matter of Example 1 includes, wherein: the optical equalizer circuit compensates for frequency-dependent attenuation of the modulated signal caused by the optical modulator.

In Example 3, the subject matter of Examples 1–2 includes, wherein: the device comprises a photonic integrated circuit (PIC) integrating the optical modulator and the optical equalizer circuit.

In Example 4, the subject matter of Example 3 includes, wherein: the PIC comprises a hybrid Si-InP PIC comprising one or more silicon layers and one or more indium phosphide layers.

In Example 5, the subject matter of Examples 1–4 includes, wherein: the optical modulator comprises an electro-absorption modulator (EAM) or a Mach-Zehnder modulator (MZM).

In Example 6, the subject matter of Examples 1–5 includes, wherein: the optical equalizer circuit comprises a Mach-Zehnder interferometer (MZI) structure comprising: a first arm comprising the direct path; and a second arm comprising the delay path.

In Example 7, the subject matter of Examples 1–6 includes, wherein: the optical amplifier comprises a semiconductor optical amplifier (SOA).

In Example 8, the subject matter of Examples 1–7 includes, wherein: the device is configured to operate at data rates of 400 Gigabits per second or higher.

In Example 9, the subject matter of Examples 1–8 includes, wherein; the optical amplifier comprises a delay path amplifier; and the delay path amplifier amplifies the delayed modulated signal before the delayed modulated signal is received by the phase shifter.

In Example 10, the subject matter of Examples 1–9 includes, wherein: the optical amplifier comprises a direct path amplifier; and the device further comprises a delay path amplifier.

In Example 11, the subject matter of Examples 1–10 includes, wherein: the optical equalizer circuit further comprises: an output amplifier to amplify the combined modulated signal.

In Example 12, the subject matter of Examples 1–11 includes, one or more additional optical equalizer circuits arranged in series with the optical equalizer circuit to form a cascade of optical equalizer circuits, such that the combined modulated signal generated by each prior optical equalizer circuit in the cascade is received by a power splitter of a subsequent optical equalizer circuit in the cascade.

In Example 13, the subject matter of Example 12 includes, wherein: each optical equalizer circuit of the cascade has a delay line in its delay path introducing a delay that is different from the delay introduced by the delay line of each other optical equalizer circuit of the cascade.

Example 14 is a method comprising: modulating light using an optical modulator to generate a modulated signal; and equalizing the modulated signal using an optical equalizer circuit to: receive the modulated signal; couple a first portion of the modulated signal onto a direct path; couple a second portion of the modulated signal onto a delay path; introduce a delay into the second portion of the modulated signal traversing the delay path, thereby generating a delayed modulated signal; shift a phase of the delayed modulated signal, thereby generating a phase-shifted modulated signal; amplify the first portion of the modulated signal or the second portion of the modulated signal by: using a direct path amplifier to amplify the first portion of the modulated signal traversing the direct path; or using a delay path amplifier to amplify the second portion of the modulated signal traversing the delay path; and combine the first portion of the modulated signal received from the direct path and the phase-shifted modulated signal received from the delay path to generate a combined modulated signal.

In Example 15, the subject matter of Example 14 includes, wherein: the equalizing of the modulated signal comprises: compensating for frequency-dependent attenuation of the modulated signal caused by the optical modulator.

In Example 16, the subject matter of Examples 14–15 includes, wherein: the amplifying of the first portion of the modulated signal or the second portion of the modulated signal comprises: using a direct path amplifier to amplify the first portion of the modulated signal traversing the direct path; and the method further comprises: using a delay path amplifier to amplify the second portion of the modulated signal traversing the delay path.

In Example 17, the subject matter of Examples 14–16 includes, amplifying the combined modulated signal using an output amplifier.

Example 18 is a method for calibrating an integrated optical modulator and optical equalizer circuit, the method comprising: applying a test signal to the optical modulator; detecting a combined modulated signal generated by the optical equalizer, the optical equalizer circuit generating the combined modulated signal by combining an output of a direct path with an output of a delay path, the output of the delay path being delayed, and phase shifted by a phase shifter; and at least one of the output of the direct path or the output of the delay path being amplified by an optical amplifier; analyzing the combined modulated signal to determine at least one performance metric; based on the determined at least one performance metric, adjusting at least one of: a gain of the optical amplifier; or a phase adjustment of the phase shifter; and repeating the applying of the test signal, the detecting of the combined modulated signal, the analyzing of the combined modulated signal, and the adjusting of the at least one of the gain or phase adjustment until the performance metric meets a predetermined criterion.

In Example 19, the subject matter of Example 18 includes, wherein: the method further comprises applying a low frequency dither signal to the phase shifter; the analyzing of the combined modulated signal to determine the at least one performance metric comprises: performing a Fourier transform on the combined modulated signal; and identifying a fundamental frequency component and a second harmonic component of the Fourier transform of the combined modulated signal; and the adjusting at least one of the gain of the optical amplifier or the phase adjustment of the phase shifter comprises: adjusting a bias of the phase shifter to minimize the fundamental frequency component and maximize the second harmonic component.

In Example 20, the subject matter of Examples 18–19 includes, wherein: the method further comprises applying a ramp signal to the phase shifter; the analyzing of the combined modulated signal to determine the at least one performance metric comprises: determining a first derivative of the combined modulated signal; and the adjusting at least one of the gain of the optical amplifier or the phase adjustment of the phase shifter comprises: adjusting a bias of the phase shifter corresponding to a zero value of the first derivative.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

What is claimed is:

1. A device comprising:
an optical modulator to modulate light to generate a modulated signal; and
an optical equalizer circuit comprising:
a power splitter to receive the modulated signal, couple a first portion of the modulated signal onto a direct path, and couple a second portion of the modulated signal onto a delay path;
a delay line to introduce a delay into the second portion of the modulated signal traversing the delay path, thereby generating a delayed modulated signal;
a phase shifter to shift a phase of the delayed modulated signal, thereby generating a phase-shifted modulated signal;
an optical amplifier comprising one of:
a direct path amplifier to amplify the first portion of the modulated signal traversing the direct path; or
a delay path amplifier to amplify the second portion of the modulated signal traversing the delay path; and
a combiner to combine the first portion of the modulated signal received from the direct path and the phase-shifted modulated signal received from the delay path to generate a combined modulated signal.

2. The device of claim 1, wherein:
the optical equalizer circuit compensates for frequency-dependent attenuation of the modulated signal caused by the optical modulator.

3. The device of claim 1, wherein:
the device comprises a photonic integrated circuit (PIC) integrating the optical modulator and the optical equalizer circuit.

4. The device of claim 3, wherein:
the PIC comprises a hybrid Si-InP PIC comprising one or more silicon layers and one or more indium phosphide layers.

5. The device of claim 1, wherein:
the optical modulator comprises an electro-absorption modulator or a Mach-Zehnder modulator.

6. The device of claim 1, wherein:
the optical equalizer circuit comprises a Mach-Zehnder interferometer structure comprising:
a first arm comprising the direct path; and
a second arm comprising the delay path.

7. The device of claim 1, wherein:
the optical amplifier comprises a semiconductor optical amplifier.

8. The device of claim 1, wherein:
the device is configured to operate at data rates of 400 Gigabits per second or higher.

9. The device of claim 1, wherein;
the optical amplifier comprises a delay path amplifier; and
the delay path amplifier amplifies the delayed modulated signal before the delayed modulated signal is received by the phase shifter.

10. The device of claim 1, wherein:
the optical amplifier comprises a direct path amplifier; and
the device further comprises a delay path amplifier.

11. The device of claim 1, wherein:
the optical equalizer circuit further comprises:
an output amplifier to amplify the combined modulated signal.

12. The device of claim 1, further comprising:
one or more additional optical equalizer circuits arranged in series with the optical equalizer circuit to form a cascade of optical equalizer circuits, such that the combined modulated signal generated by each prior optical equalizer circuit in the cascade is received by a power splitter of a subsequent optical equalizer circuit in the cascade.

13. The device of claim 12, wherein:
each optical equalizer circuit of the cascade has a delay line in its delay path introducing a delay that is different from the delay introduced by the delay line of each other optical equalizer circuit of the cascade.

14. A method comprising:
modulating light using an optical modulator to generate a modulated signal; and
equalizing the modulated signal using an optical equalizer circuit to:
receive the modulated signal;
couple a first portion of the modulated signal onto a direct path;
couple a second portion of the modulated signal onto a delay path;
introduce a delay into the second portion of the modulated signal traversing the delay path, thereby generating a delayed modulated signal;
shift a phase of the delayed modulated signal, thereby generating a phase-shifted modulated signal;
amplify the first portion of the modulated signal or the second portion of the modulated signal by:
using a direct path amplifier to amplify the first portion of the modulated signal traversing the direct path; or
using a delay path amplifier to amplify the second portion of the modulated signal traversing the delay path; and
combine the first portion of the modulated signal received from the direct path and the phase-shifted modulated signal received from the delay path to generate a combined modulated signal.

15. The method of claim 14, wherein:
the equalizing of the modulated signal comprises:
compensating for frequency-dependent attenuation of the modulated signal caused by the optical modulator.

16. The method of claim 14, wherein:
the amplifying of the first portion of the modulated signal or the second portion of the modulated signal comprises:
using a direct path amplifier to amplify the first portion of the modulated signal traversing the direct path; and
the method further comprises:
using a delay path amplifier to amplify the second portion of the modulated signal traversing the delay path.

17. The method of claim 14, further comprising:
amplifying the combined modulated signal using an output amplifier.

18. A method for calibrating an integrated optical modulator and optical equalizer circuit, the method comprising:
applying a test signal to the optical modulator;
detecting a combined modulated signal generated by the optical equalizer, the optical equalizer circuit generating the combined modulated signal by combining an output of a direct path with an output of a delay path,
the output of the delay path being delayed, and phase shifted by a phase shifter; and
at least one of the outputs of the direct path or the output of the delay path being amplified by an optical amplifier;
analyzing the combined modulated signal to determine at least one performance metric;
based on at least one performance metric, adjusting at least one of:
a gain of the optical amplifier; or
a phase adjustment of the phase shifter; and
repeating the applying of the test signal, the detecting of the combined modulated signal, the analyzing of the combined modulated signal, and the adjusting of the at least one of the gain or phase adjustment until the performance metric meets a predetermined criterion.

19. The method of claim 18, wherein:
the method further comprises applying a low frequency dither signal to the phase shifter;
the analyzing of the combined modulated signal to determine the at least one performance metric comprises:
performing a Fourier transform on the combined modulated signal; and
identifying a fundamental frequency component and a second harmonic component of the Fourier transform of the combined modulated signal; and
the adjusting at least one of the gain of the optical amplifier or the phase adjustment of the phase shifter comprises:
adjusting a bias of the phase shifter to minimize the fundamental frequency component and maximize the second harmonic component.

20. The method of claim 18, wherein:
the method further comprises applying a ramp signal to the phase shifter;
the analyzing of the combined modulated signal to determine the at least one performance metric comprises:
determining a first derivative of the combined modulated signal; and
the adjusting at least one of the gain of the optical amplifier or the phase adjustment of the phase shifter comprises:
adjusting a bias of the phase shifter corresponding to a zero value of the first derivative.
